(19) United States
(12) Patent Application Publication
(10) Pub. No.: US 2022/0306106 A1
(43) Pub. Date: Sep. 29, 2022

(54) VEHICLE CONTROL DEVICE, VEHICLE CONTROL METHOD, AND STORAGE MEDIUM

(71) Applicant: HONDA MOTOR CO., LTD., Tokyo (JP)

(72) Inventors: Atsuhiro Sekikawa, Wako-shi (JP); Shotaro Taniguchi, Wako-shi (JP)

(21) Appl. No.: 17/680,408

(22) Filed: Feb. 25, 2022

(30) Foreign Application Priority Data
Mar. 29, 2021 (JP) 2021-055558

(51) Int. Cl. B60W 30/182; B60W 40/08; B60W 30/18; B60W 40/105; B60W 50/14; B60W 10/20; G06V 20/59; G06V 40/16; G06V 40/10

(52) U.S. Cl. CPC B60W 30/182; B60W 40/08; B60W 30/18163; B60W 40/105; B60W 50/14; B60W 10/20; G06V 20/597; G06V 40/161; G06V 40/103; B60W 2040/0827; B60W 2050/143; B60W 2050/146; B60W 2420/42; B60W 2540/223; B60W 2540/225; B60W 2540/229

(57) ABSTRACT

A vehicle control device of an embodiment includes a detector that detects some or all of a degree of awakeness of a driver of a vehicle, an orientation of a face of the driver, and an orientation of a line of sight of the driver, and a driving controller that subjects the vehicle to a lane change by controlling at least one of a speed and steering of the vehicle, in which the driving controller changes a mode of the lane change on the basis of a detection result from the detector.

### CROSS-REFERENCE TO RELATED APPLICATION

This application is based upon and claims the benefit of priority from Japanese Patent Application No. 2021-055558, filed Mar. 29, 2021, the entire contents of which is incorporated herein by reference.

### BACKGROUND

### Field of the Invention

The present invention relates to a vehicle control device, a vehicle control method, and a storage medium.

### Description of Related Art

There is a technique for changing lanes while reducing the maximum lateral acceleration and maximum lateral speed according to a width of a lane that is a lane change destination (refer to, for example, Japanese Unexamined Patent Application, First Publication No. 2017-100354).

### SUMMARY

However, in the technique of the related art, lane changing occurs even when a driver is not facing the front, and thus the driver may get carsick. In the technique of the related art, it has not been examined to change lanes while considering the degree of awakeness of a driver.

One aspect of the present invention has been made in consideration of such circumstances, and one object thereof is to provide a vehicle control device, a vehicle control method, and a storage medium capable of performing a more comfortable lane change for a driver.

A vehicle control device, a vehicle control method, and a storage medium according to the present invention have the following configurations.

According to one aspect (1) of the present disclosure, a vehicle control device is provided including a detector that detects some or all of a degree of awakeness of a driver of a vehicle, an orientation of a face of the driver, and an orientation of a line of sight of the driver; and a driving controller that subjects the vehicle to a lane change by controlling at least one of a speed and steering of the vehicle, in which the driving controller changes a mode of the lane change on the basis of a detection result from the detector.

According to an aspect (2), in the vehicle control device of the above aspect (1), the driving controller determines whether or not the driver is facing the front in the vehicle within a period from a time point at which the lane change is possible until a predetermined time elapses, or from the time point at which the lane change is possible until the vehicle travels a predetermined distance on the basis of the detection result from the detector and performs the lane change in a case where it is determined that the driver is facing the front in the vehicle within the period.

According to an aspect (3), in the vehicle control device of the above aspect (2), in a case where it is determined that the driver is not facing the front in the vehicle within the period, the driving controller outputs information for prompting the driver to face the front in the vehicle by using an outputter.

According to an aspect (4), in the vehicle control device of any one of the above aspects (1) to (3), the driving controller determines whether or not the driver is facing the front in the vehicle within a first period from a time point at which the lane change is possible until a first predetermined time elapses, or from the time point at which the lane change is possible until the vehicle travels a first predetermined distance on the basis of the detection result from the detector, performs the lane change in a case where it is determined that the driver is facing the front in the vehicle within the first period, in a case where it is determined that the driver is not facing the front in the vehicle within the first period, activates a direction indicator and determines whether or not the driver is facing the front in the vehicle within a second period from the first period until a second predetermined time elapses, or from the first period until the vehicle travels a second predetermined distance on the basis of the detection result from the detector, and in a case where it is determined that the driver is not facing the front in the vehicle within the second period, the driving controller outputs information for prompting the driver to face the front in the vehicle by using an outputter.

According to an aspect (5), in the vehicle control device of any one of the above aspects (1) to (4), the driving controller restricts the lane change in a case where the degree of awakeness detected by the detector is less than a threshold value.

According to another aspect (6) of the present invention, a vehicle control method of causing a computer mounted on a vehicle is provided to detect some or all of a degree of awakeness of a driver of the vehicle, an orientation of a face of the driver, and an orientation of a line of sight of the driver; subject the vehicle to a lane change by controlling at least one of a speed and steering of the vehicle; and change a mode of the lane change on the basis of a detected result.

According to still another aspect (7) of the present invention, a non-transitory storage medium storing computer-readable instructions for causing a computer mounted on a vehicle to execute detecting some or all of a degree of awakeness of a driver of the vehicle, an orientation of a face of the driver, and an orientation of a line of sight of the driver; subjecting the vehicle to a lane change by controlling at least one of a speed and steering of the vehicle; and changing a mode of the lane change on the basis of a detected result.

According to any one of the above aspects, it is possible to perform a more comfortable lane change for a driver.

### BRIEF DESCRIPTION OF THE DRAWINGS

FIG. 1 is a configuration diagram of a vehicle system using a vehicle control device according to an embodiment.

FIG. 2 is a functional configuration diagram of a first controller and a second controller.

FIG. 3 is a diagram showing an example of a correspondence relationship between a driving mode, a control state of an own vehicle M, and a task.

FIG. 4 is a flowchart showing an example of a flow of a series of processes by an automated driving control device of the embodiment.

FIG. 5 is a flowchart showing an example of a flow of a series of processes based on the degree of awakeness of a driver.

FIG. 6 is a diagram showing an example of a hardware configuration of the automated driving control device of the embodiment.

### DESCRIPTION OF EMBODIMENTS

Hereinafter, embodiments of a vehicle control device, a vehicle control method, and a storage medium of the present invention will be described with reference to the drawings.

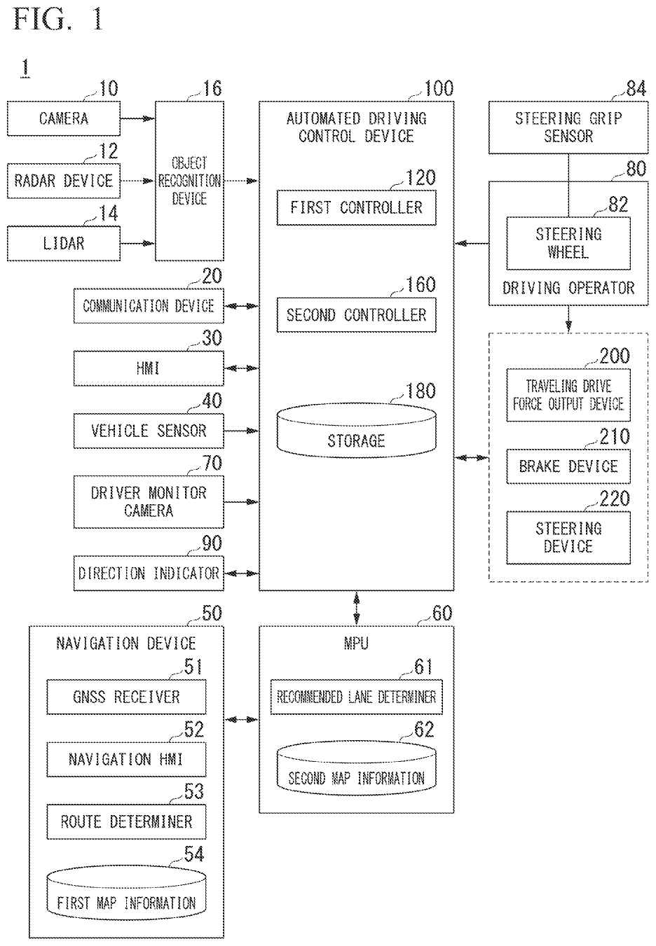

Overall configuration FIG. 1 is a configuration diagram of a vehicle system 1 using a vehicle control device according to an embodiment. A vehicle (hereinafter, an own vehicle M) having the vehicle system 1 mounted therein is, for example, a two-wheeled, three-wheeled, or four-wheeled vehicle, and a drive source thereof is an internal combustion engine such as a diesel engine or a gasoline engine, a motor, or a combination thereof. The motor is operated by using power generated by a generator connected to the internal combustion engine or power released from a secondary battery or a fuel cell.

The vehicle system 1 includes, for example, a camera 10, a radar device 12, light detection and ranging (LIDAR) 14, an object recognition device 16, a communication device 20, a human machine interface (HMI) 30, a vehicle sensor 40, a navigation device 50, a map positioning unit (MPU) 60, a driver monitor camera 70, a driving operator 80, a direction indicator 90, an automated driving control device 100, a traveling drive force output device 200, a brake device 210, and a steering device 220. The devices and the apparatuses are connected to each other via a multiplex communication line such as a Controller Area Network (CAN) communication line, a serial communication line, or a wireless communication network. The configuration shown in FIG. 1 is only an example, and some of the constituents may be omitted, and other constituents may be added. The automated driving control device 100 is an example of a “vehicle control device”.

The camera 10 is a digital camera using a solid-state imaging element such as a charge coupled device (CCD) or a complementary metal oxide semiconductor (CMOS). The camera 10 is attached at any location in a vehicle in which the vehicle system 1 is mounted. For example, in a case of imaging the front in the own vehicle M, the camera 10 is attached to the upper part of a front windshield, the back surface of a rearview mirror, or the like. In a case of imaging the rear of the own vehicle M, the camera 10 is attached to the upper part of a rear windshield or the like. In a case of imaging the right side or the left side of the own vehicle M, the camera 10 is attached to a vehicle body or a right side surface or a left side surface of a door mirror. The camera 10 periodically and repeatedly captures images of the periphery of the own vehicle M. The camera 10 may be a stereo camera.

The radar device 12 radiates electric waves such as millimeter waves in the surroundings of the own vehicle M, detects electric waves (reflected waves) reflected by an object, and thus detects at least a position of (a distance to and an azimuth of) the object. The radar device 12 is attached at any location in the own vehicle M. The radar device 12 may detect a position and a speed of an object according to a frequency modulated continuous wave (FM-CW) method.

The LIDAR 14 applies light (or an electromagnetic wave with a wavelength close to that of the light) in the surroundings of the own vehicle M and measures scattered light. The LIDAR 14 detects a distance to a target on the basis of a time from light emission to light reception. The applied light is, for example, pulsed laser light. The LIDAR 14 is attached at any location in the own vehicle M.

The object recognition device 16 performs a sensor fusion process on detection results from some or all of the camera 10, the radar device 12, and the LIDAR 14, and thus recognizes a position, the type (attribute), a speed, and the like of an object. The object recognition device 16 outputs a recognition result to the automated driving control device 100. The object recognition device 16 may output detection results from the camera 10, the radar device 12, and the LIDAR 14 to the automated driving control device 100 without change. The object recognition device 16 may be omitted from the vehicle system 1.

The communication device 20 performs communication with another vehicle present in the surroundings of the own vehicle M or performs communication with various server apparatuses via a wireless base station by using, for example, a cellular network, a Wi-Fi network, Bluetooth (registered trademark), or dedicated short range communication (DSRC).

The HMI 30 presents various types of information to an occupant (including a driver) of the own vehicle M, and also receives an input operation from the occupant. For example, the HMI 30 may include a display device, a switch, a speaker, a buzzer, a touch panel, and the like. For example, the occupant inputs a destination of the own vehicle M to the HMI 30. The HMI 30 is an example of an “outputter”.

The vehicle sensor 40 includes a vehicle speed sensor that detects a speed of the own vehicle M, an acceleration sensor that detects acceleration, a gyro sensor that detects angular velocity, an azimuth sensor that detects an orientation of the own vehicle M, and the like. The gyro sensor may include, for example, a yaw rate sensor that detects an angular velocity about a vertical axis.

The navigation device 50 includes, for example, a global navigation satellite system (GNSS) receiver 51, a navigation HMI 52, and a route determiner 53. The navigation device 50 stores first map information 54 in a storage device such as a hard disk drive (HDD) or a flash memory.

The GNSS receiver 51 receives electric waves from each of a plurality of GNSS satellites (artificial satellites) and specifies a position of the own vehicle M on the basis of signals of the received electric waves. The GNSS receiver 51 outputs the specified position of the own vehicle M to the route determiner 53, or outputs the position directly to the automated driving control device 100 or indirectly via the MPU 60. A position of the own vehicle M may be specified or complemented by an inertial navigation system (INS) using an output from the vehicle sensor 40.

The navigation HMI 52 includes a display device, a speaker, a touch panel, keys, and the like. The navigation HMI 52 may be partially or entirely integrated into the HMI 30 described above. For example, an occupant may enter a destination of the own vehicle M to the navigation HMI 52 instead of or in addition to inputting the destination of the own vehicle M to the HMI 30.

The route determiner 53 determines, for example, a route (hereinafter, a route on a map) from a position of the own vehicle M specified by the GNSS receiver 51 (or any entered position) to a destination that is entered by an occupant by using the HMI 30 or the navigation HMI 52 on the basis of the first map information 54.

The first map information 54 is, for example, information in which a road shape is expressed by a link indicating a road and nodes connected to each other via the link. The first map information 54 may include a curvature of a road, point of interest (POI) information, and the like. The route on the map is output to MPU 60.

The navigation device 50 may perform route guidance using the navigation HMI 52 on the basis of the route on the map. The navigation device 50 may be implemented, for example, by a function of a terminal apparatus such as a smartphone or a tablet terminal carried by the occupant. The navigation device 50 may transmit the current position and the destination to a navigation server via the communication device 20 and may acquire a route equivalent to the route on the map from the navigation server.

The MPU 60 includes, for example, a recommended lane determiner 61, and stores second map information 62 in a storage device such as an HDD or a flash memory. The recommended lane determiner 61 is realized by a hardware processor such as a central processing unit (CPU) executing a program (software). The recommended lane determiner 61 may be realized by hardware (a circuit portion; including circuitry) such as a large-scale integration (LSI), an application specific integrated circuit (ASIC), a field-programmable gate array (FPGA), or a graphics processing unit (GPU), and may be realized by software and hardware in cooperation. The program may be stored in advance in a storage device (a storage device provided with a non-transitory storage medium) of the MPU 60 and may be stored in an attachable and detachable storage medium such as a DVD or a CD-ROM and may be installed in the storage device of the MPU 60 when the storage medium (non-transitory storage medium) is attached to a drive device.

The recommended lane determiner 61 divides the route on the map provided from the navigation device 50 into a plurality of blocks (for example, divides the route on the map every 100 m in a vehicle advancing direction) and determines a recommended lane for each block by referring to the second map information 62. The recommended lane determiner 61 determines in which lane from the left the own vehicle will travel. In a case where there is a branch location on the route on the map, the recommended lane determiner 61 determines a recommended lane such that the own vehicle M can travel on a reasonable route to advance to a branch destination.

The second map information 62 is map information with higher accuracy than that of the first map information 54. The second map information 62 includes, for example, lane center information or lane boundary information. The second map information 62 may include road information, traffic regulation information, address information (address/postal code), facility information, telephone number information, and the like. The second map information 62 may be updated at any time by the communication device 20 performing communication with other devices.

The driver monitor camera 70 is, for example, a digital camera that uses a solid-state imaging sensor such as a CCD or a CMOS. The driver monitor camera 70 is attached to any position in the own vehicle M at a position and an orientation in which an occupant (that is, a driver) seated on a driver's seat of the own vehicle M can be imaged from the front. For example, the driver monitor camera 70 is attached to an instrument panel of the own vehicle M.

The driving operator 80 includes, for example, an accelerator pedal, a brake pedal, a shift lever, and other operators in addition to a steering wheel 82. A sensor that detects an amount of operation or the presence or absence of operation is attached to the driving operator 80. A detection result from the sensor is output to the automated driving control device 100 or is output to some or all of the traveling drive force output device 200, the brake device 210, and the steering device 220.

The steering wheel 82 does not necessarily have to be annular and may have a form of an odd-shaped steering wheel, a joystick, a button, or the like. A steering grip sensor 84 is attached to the steering wheel 82. The steering grip sensor 84 is a capacitance sensor or the like. The steering grip sensor 84 detects whether or not the driver is gripping the steering wheel 82 (meaning that the driver is in contact with the steering wheel 82 in a state in which a force is being applied thereto), and outputs a signal indicating the detection result to the automated driving control device 100.

The direction indicator (also called a winker or a turn lamp) 90 is a lamp that indicates a direction of turning left or right or a direction of course change to the surroundings. The direction indicator 90 includes a direction indicator lever 92. The direction indicator lever 92 may be attached, for example, in the vicinity of the steering wheel 82. When the occupant operates the direction indicator lever 92, the direction indicator 90 is activated. The “activation” means an operation of turning on or blinking a lamp (turn lamp) that functions as the direction indicator 90.

The automated driving control device 100 includes, for example, a first controller 120, a second controller 160, and a storage 180. Each of the first controller 120 and the second controller 160 is realized, for example, by a hardware processor such as a CPU executing a program (software). Some or all of the constituents may be realized by hardware (a circuit portion; including circuitry) such as an LSI, an ASIC, an FPGA, or a GPU, and may be realized by software and hardware in cooperation. The program may be stored in advance in a storage device (a storage device provided with a non-transitory storage medium) such as an HDD or a flash memory of the automated driving control device 100 and may be stored in an attachable and detachable storage medium such as a DVD or a CD-ROM and may be installed in the HDD or the flash memory of the automated driving control device 100 when the storage medium (non-transitory storage medium) is attached to a drive device.

The storage 180 is implemented by, for example, an HDD, a flash memory, an EEPROM, a ROM, a RAM, or the like. The storage 180 stores, for example, a program read and executed by a processor.

FIG. 2 is a functional configuration diagram of the first controller 120 and the second controller 160. The first controller 120 includes, for example, a recognizer 130, an action plan generator 140, and a mode controller 150. A combination of the action plan generator 140 and the second controller 160, or a combination of the action plan generator 140, the mode controller 150, and the second controller 160 is an example of a “driving controller”.

The first controller 120 is realized by combining, for example, a function of artificial intelligence (AI) with a function of a model provided in advance. For example, a function of “recognizing an intersection” may be realized by executing recognition of the intersection using deep learning and recognition based on conditions (for example, there are a signal that can be matched with a pattern, and a road marking) given in advance in parallel and scoring and comprehensively evaluating both of recognition results. Consequently, the reliability of automated driving is ensured.

The recognizer 130 recognizes situations or environments in the surroundings of the own vehicle M. For example, the recognizer 130 recognizes an object present in the surroundings of the own vehicle M on the basis of information input from the camera 10, the radar device 12, and the LIDAR 14 via the object recognition device 16. Objects recognized by the recognizer 130 include, for example, bicycles, motorcycles, four-wheeled vehicles, pedestrians, road signs, road markings, lane markings, utility poles, guardrails, and falling objects. The recognizer 130 recognizes states of the object such as a position, a speed, and an acceleration. The position of the object is recognized as, for example, a position (that is, a relative position with respect to the own vehicle M) in a relative coordinate system having a representative point (for example, the centroid or the drive axis center) of the own vehicle M as an origin and is used for control. The position of the object may be represented by a representative point such as the centroid or a corner of the object and may be represented by an expressed region. The “states” of the object may include an acceleration, a jerk, or an “action state” of the object (for example, whether or not the object is changing lanes or trying to change lanes).

The recognizer 130 recognizes, for example, a lane in which the own vehicle M is traveling (hereinafter, an own lane) and an adjacent lane that is adjacent to the own lane. For example, the recognizer 130 acquires the second map information 62 from the MPU 60, compares a pattern (for example, an arrangement of solid lines and dashed lines) of road lane markings included in the obtained second map information 62 with a pattern of road lane markings in the surroundings of the own vehicle M recognized from an image captured by the camera 10, and thus recognizes a space between the lane markings as an own lane or an adjacent lane.

The recognizer 130 is not limited to a road lane marking and may recognize a boundary representing a lane boundary (road boundary) such as a road lane marking, a road shoulder, a curb, a median strip, and a guardrail, to recognize lanes such as an own lane or an adjacent lane. In this recognition, a position of the own vehicle M acquired from the navigation device 50 or a process result from an INS may be taken into consideration. The recognizer 130 recognizes a temporary stop line, an obstacle, a red light, a tollgate, or other road events.

When the own lane is recognized, the recognizer 130 recognizes a relative position and a posture of the own vehicle M with respect to the own lane. The recognizer 130 may recognize, for example, a deviation of a reference point of the own vehicle M from the lane center and an angle formed with a line connecting coordinate points of the lane centers in an advancing direction of the own vehicle M as a relative position and a posture of the own vehicle M with respect to the own lane. Alternatively, the recognizer 130 may recognize a position or the like of the reference point of the own vehicle M with respect to either of side ends (road lane markings or road boundaries) of the own lane as the relative position of the own vehicle M with respect to the own lane.

The action plan generator 140 generates target trajectories in which the own vehicle M automatedly (regardless of an operation of a driver) travels in the future in a state during traveling defined by an event that will be described later such that the own vehicle M can travel in a recommended lane determined by the recommended lane determiner 61 in principle and can also cope with a surrounding situation of the own vehicle M.

The target trajectory includes, for example, a speed element. For example, the target trajectory is expressed by sequentially arranging locations (trajectory points) to be reached by the own vehicle M. The trajectory points are locations to be reached by the own vehicle M every predetermined traveling distance (for example, about several [m]) in terms of a distance along a road, and, separately therefrom, a target speed and a target acceleration for each predetermined sampling time (for example, any of about 0.1 to 0.9 seconds) are generated as parts of the target trajectory. A trajectory point may be a position to be reached by the own vehicle M at a sampling time point every predetermined sampling time. In this case, information regarding the target speed or the target acceleration may be expressed by an interval between trajectory points.

The action plan generator 140 may generate a target trajectory in which the own vehicle M exceptionally travels in another lane different from a recommended lane (for example, a lane adjacent to the recommended lane) in order to cope with the surrounding situation of the own vehicle M. That is, a priority of other lanes other than the recommended lane is relatively lower than a priority of the recommended lane. For example, the recommended lane has the highest priority (priority 1), another lane (hereinafter, an adjacent lane) adjacent to the recommended lane has the second highest priority (priority 2), and still another adjacent lane that is adjacent to the adjacent lane has the third highest priority (priority 3). As described above, the action plan generator 140 generates a target trajectory in which the own vehicle M travels in the recommended lane having the highest priority in principle and generates a target trajectory in which the own vehicle M exceptionally travels in another lane having a lower priority than that of the recommended lane depending on a surrounding situation of the own vehicle M.

The action plan generator 140 determines an automated driving event (including partial driving assistance) on a route where the recommended lane is determined when generating the target trajectory. The automated driving event is information defining a behavior that the own vehicle M has to take under automated driving (partial driving assistance), that is, the state during traveling (or a mode during traveling).

The automated driving event includes, for example, a constant speed traveling event, a low speed following traveling event, a lane change event, and a passing event. The constant speed traveling event is an event in which the own vehicle M travels in the same lane at a constant speed. The low speed following traveling event is an event in which the own vehicle M follows another vehicle (hereinafter, referred to as a preceding vehicle) that is present within a predetermined distance (for example, within 100 [m]) in front of the own vehicle M and is closest to the own vehicle M. The “following” may be, for example, a traveling state in which a relative distance (inter-vehicle distance) between the own vehicle M and the preceding vehicle is kept constant, or a traveling state in which the own vehicle M travels in the center of the own lane in addition to keeping the relative distance between the own vehicle M and the preceding vehicle constant. The lane change event is an event in which a lane of the own vehicle M is changed from the own lane to an adjacent lane. The passing event is an event in which the own vehicle M temporarily changes a lane to an adjacent lane, passes the preceding vehicle in the adjacent lane, and then performs a lane change from the adjacent lane to the original lane again.

The automated driving event further includes a branching event, a merging event, a lane reduction event, a takeover event, and the like. The branching event is an event in which, in a case where the own vehicle M is traveling in a main lane and a destination thereof is located on an extension of a branch line (hereinafter, a branch lane) branched from the main lane, the own vehicle M is guided to change a lane from the main lane to the branch lane at a branch location. The merging event is an event in which, in a case where the own vehicle M is traveling on a branch line (hereinafter, a merging lane) which merges into a main lane and a destination thereof is located on an extension of the main lane, the own vehicle M is guided to change a lane from the merging lane to the main lane at a merging location. The lane reduction event is an event in which the own vehicle M changes a lane to another lane when traveling on a route in which the number of lanes is decreasing on the way. The takeover event is an event for finishing an automated driving mode (a mode A that will be described later) and switching to a driving assistance mode (a mode B, C, or D that will be described later) or a manual driving mode (a mode E that will be described later). For example, a lane marking may be interrupted in front of a tollhouse on an expressway, and a relative position of the own vehicle M may not be recognized. In such a case, a takeover event is determined (planned) for a section in front of the tollhouse.

The action plan generator 140 sequentially determines these plurality of events on the route to the destination, and generates a target trajectory for causing the own vehicle M to travel in a state defined by each event while considering a surrounding situation of the own vehicle M.

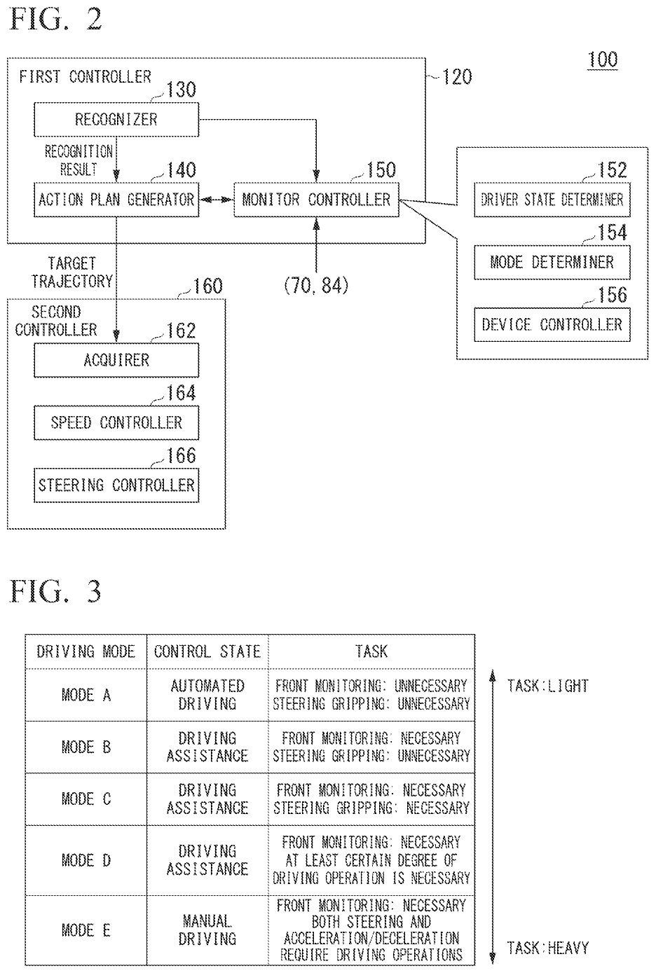

The mode controller 150 determines a driving mode of the own vehicle M to be one of a plurality of driving modes. The plurality of driving modes respectively have different tasks imposed on a driver. The mode controller 150 includes, for example, a driver state determiner 152, a mode determiner 154, and a device controller 156. Individual functions thereof will be described later. A combination of the driver monitor camera 70 and the driver state determiner 152 is an example of a “detector”. FIG. 3 is a diagram showing an example of a correspondence relationship between a driving mode, a control state of the own vehicle M, and a task. Driving modes of the own vehicle M include, for example, five modes from the mode A to the mode E. A control state, that is, the degree of automation (control level) of driving control for the own vehicle M is highest in the mode A, then becomes lower in the order of the mode B, the mode C, and the mode D, and is lowest in the mode E. In contrast, a task imposed on a driver is lightest in the mode A, then becomes heavier in the order of the mode B, the mode C, and the mode D, and is heaviest in the mode E. In the modes D and E, the vehicle is in a control state that is not automated driving, and thus the automated driving control device 100 is responsible for finishing control related to automated driving and transitioning to driving assistance or manual driving. Hereinafter, details of each driving mode will be exemplified.

In the mode A, the vehicle is in an automated driving state, and neither front monitoring nor gripping of the steering wheel 82 (steering gripping in the figure) is imposed on the driver. However, even in the mode A, the driver is required to be in a posture to quickly transition to manual driving in response to a request from the system centered on the automated driving control device 100. The term “automated driving” referred to here means that both steering and acceleration/deceleration are controlled without depending on the driver's operation. The term “front” means a space in an advancing direction of the own vehicle M that is visually recognized through the front windshield. The mode A is a driving mode that is executable in a case of satisfying a condition that the own vehicle M is traveling at a predetermined speed (for example, about 50 km/h]) or less on a motorway such as an expressway and there is a preceding vehicle that is a following target and may be referred to as traffic jam pilot (TJP). In a case where this condition is no longer satisfied, the mode controller 150 changes a driving mode of the own vehicle M to the mode B.

In the mode B, the vehicle is in a driving assistance state, and the task of monitoring the front in the own vehicle M (hereinafter, front monitoring) is imposed on the driver, but the task of gripping the steering wheel 82 is not imposed on the driver. In the mode C, the vehicle is in a driving assistance state, and the task of front monitoring and the task of gripping the steering wheel 82 are imposed on the driver. The mode D is a driving mode that requires a certain degree of driving operation by the driver with respect to at least one of steering and acceleration/deceleration of the own vehicle M. For example, in the mode D, driving assistance such as adaptive cruise control (ACC) or lane keeping assist system (LKAS) is provided. In the mode E, the vehicle is in a manual operation state in which both steering and acceleration/deceleration require driving operations by the driver. In both the mode D and the mode E, the task of monitoring the front in the own vehicle M is naturally imposed on the driver.

The automated driving control device 100 (and a driving assistance device (not shown)) executes an automated lane change according to a driving mode. The automated lane change includes an automated lane change (1) according to a system request and an automated lane change (2) according to a driver request. The automated lane change (1) includes an automated lane change for passing in a case where a speed of a preceding vehicle is lower than a speed of the own vehicle by a reference or more and an automated lane change for advancing toward a destination (an automated lane change due to a change of a recommended lane). The automated lane change (2) is to change a lane of the own vehicle M toward an operation direction when the direction indicator is operated by the driver in a case where conditions related to a speed or a positional relationship with surrounding vehicles are satisfied.

The automated driving control device 100 does not execute either the automated lane change (1) or (2) in the mode A. The automated driving control device 100 executes both the automated lane change (1) and (2) in modes B and C. The driving assistance device (not shown) does not execute the automated lane change (1) but executes the automated lane change (2) in the mode D. In the mode E, neither automated lane change (1) nor (2) is executed.

FIG. 2 will be referred to again. The mode controller 150 changes a driving mode of the own vehicle M to a driving mode in which the task is heavier in a case where the task related to the determined driving mode is not executed by the driver.

For example, in the mode A, in a case where the driver is in a posture where the driver cannot transition to manual driving in response to a request from the system (for example, in a case where the driver continues to look outside a permissible area or a sign that driving becomes difficult is detected), the mode controller 150 uses the HMI 30 to prompt the driver to transition to manual driving, and if the driver does not respond, the mode controller 150 performs control of gradually bringing the own vehicle M to a road shoulder and stopping the own vehicle M to stop the automated driving. After the automated driving is stopped, the own vehicle is in the mode D or E, and the own vehicle M can be started by a manual operation of the driver. Hereinafter, the same applies to “stop automated driving”. In a case where the driver is not monitoring the front in the mode B, the mode controller 150 uses the HMI 30 to prompt the driver to monitor the front, and if the driver does not respond, the mode controller 150 performs control of gradually bringing the own vehicle M to a road shoulder and stopping the own vehicle M to stop the automated driving. In the mode C, in a case where the driver is not monitoring the front or is not gripping the steering wheel 82, the mode controller 150 uses the HMI 30 to prompt the driver to monitor the front and/or grip the steering wheel 82, and if the driver does not respond, the mode controller 150 performs control of gradually bringing the own vehicle M to a road shoulder and stopping the own vehicle M to stop the automated driving.

The driver state determiner 152 determines whether or not the driver is in a state of being able to perform a task on the basis of an image from the driver monitor camera 70 and a detection signal from the steering grip sensor 84 in order to perform the above mode change.

For example, the driver state determiner 152 analyzes the image from the driver monitor camera 70 to estimate a posture of the driver and determines whether or not the driver is in a posture to be able to transition to manual driving in response to a request from the system on the basis of the estimated posture.

The driver state determiner 152 analyzes the image from the driver monitor camera 70 to estimate an orientation of the driver's line of sight or face and determines whether or not the driver is monitoring the front in the own vehicle M on the basis of the estimated orientation of the line of sight or the face.

For example, the driver state determiner 152 detects a positional relationship between the driver's head and eyes, a combination of a reference point and a moving point in the eyes, and the like from the image from the driver monitor camera 70 by using a technique such as template matching. The driver state determiner 152 estimates the orientation of the face on the basis of a relative position of the eyes with respect to the head. The driver state determiner 152 estimates the orientation of the driver's line of sight on the basis of a position of the moving point with respect to the reference point. For example, in a case where the reference point is the inner corner of the eye, the moving point is the iris. In a case where the reference point is the corneal reflex region, the moving point is the pupil.

The driver state determiner 152 analyzes the image from the driver monitor camera 70 to determine the degree of awakeness of the driver. The driver state determiner 152 determines whether or not the driver is gripping the steering wheel 82 on the basis of the detection signal from the steering grip sensor 84.

The mode determiner 154 determines a driving mode of the own vehicle M according to the determination result from the driver state determiner 152.

The device controller 156 controls the HMI 30, the direction indicator 90, and the like on the basis of the driving mode of the own vehicle M determined by the mode determiner 154 and the determination result from the driver state determiner 152. For example, the device controller 156 may cause the HMI 30 to output information for prompting the driver to perform a task corresponding to each driving mode.

The second controller 160 controls the traveling drive force output device 200, the brake device 210, and the steering device 220 such that the own vehicle M can pass along the target trajectory generated by the action plan generator 140 as scheduled.

The second controller 160 includes, for example, an acquirer 162, a speed controller 164, and a steering controller 166. The acquirer 162 acquires information regarding the target trajectory (trajectory points) generated by the action plan generator 140 and stores the information in a memory (not shown). The speed controller 164 controls the traveling drive force output device 200 or the brake device 210 on the basis of a speed element included in the target trajectory stored in the memory. The steering controller 166 controls the steering device 220 according to a curved state of the target trajectory stored in the memory. Processes in the speed controller 164 and the steering controller 166 are realized by a combination of, for example, feedforward control and feedback control. As an example, the steering controller 166 executes a combination of feedforward control based on a curvature of a road in front of the own vehicle M and feedback control based on deviation from the target trajectory.

The traveling drive force output device 200 outputs traveling drive force (torque) for traveling of the vehicle to drive wheels. The traveling drive force output device 200 includes, for example, a combination of an internal combustion engine, a motor, and a transmission, and an electronic control unit (ECU) controlling the constituents. The ECU controls the constituents according to information that is input from the second controller 160 or information that is input from the driving operator 80.

The brake device 210 includes, for example, a brake caliper, a cylinder that transmits hydraulic pressure to the brake caliper, an electric motor that generates the hydraulic pressure in the cylinder, and a brake ECU. The brake ECU controls the electric motor on the basis of information being input from the second controller 160 or information being input from the driving operator 80, so that brake torque corresponding to a braking operation is output to each vehicle wheel. The brake device 210 may include, as a backup, a mechanism transmitting hydraulic pressure generated by operating the brake pedal included in the driving operator 80, to the cylinder via a master cylinder. The brake device 210 is not limited to the above configuration and may be an electronic control type hydraulic brake device that controls an actuator according to information being input from the second controller 160 and thus transmits hydraulic pressure in a master cylinder to the cylinder.

The steering device 220 includes, for example, a steering ECU and an electric motor. The electric motor changes an orientation of a turning wheel by applying force to, for example, a rack-and-pinion mechanism. The steering ECU drives the electric motor on the basis of information being input from the second controller 160 or information being input from the driving operator 80, so that an orientation of the turning wheel is changed.

Overall Process Flow

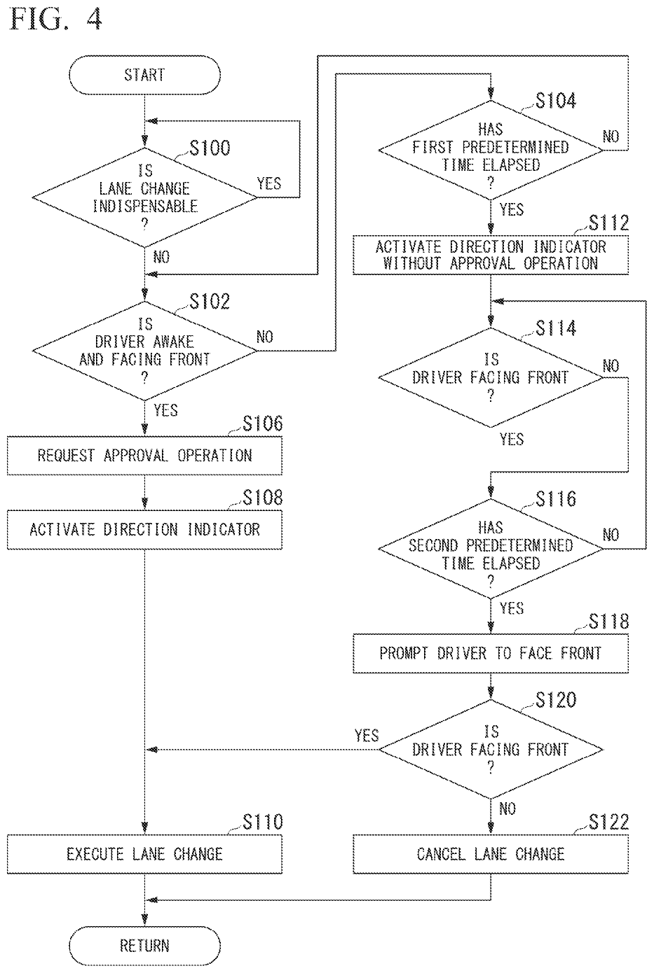

Hereinafter, a flow of a series of processes in the automated driving control device 100 of the embodiment will be described with reference to a flowchart. FIG. 4 is a flowchart showing an example of a flow of a series of processes in the automated driving control device 100 of the embodiment.

The processes in this flowchart may be repeatedly executed in a predetermined cycle, for example, under the mode A, in a case where the own vehicle M reaches a section in which an event involving a lane change is determined on a route to a destination or in a case where it is predicted that the own vehicle M will reach the section within a predetermined time or a predetermined distance.

As described above, the event involving a lane change are a lane change event, a passing event, a branching event, a merging event, a lane reduction event, or the like.

First, the driver state determiner 152 determines whether or not the event involving a lane change is an indispensable event before the vehicle reaches the destination (step S100).

For example, in a case where the event involving a lane change is an event such as a branching event, a merging event, or a lane reduction event, in which a lane change is required to be performed along a road structure, the driver state determiner 152 determines that the event is an indispensable event.

On the other hand, in a case where the event involving a lane change is a lane change event or a passing event, the driver state determiner 152 determines that the event is not an indispensable event.

When it is determined that the event involving a lane change is not an indispensable event, the driver state determiner 152 further determines whether the driver is awake and facing the front (step S102).

For example, the driver state determiner 152 calculates the degree of awakeness of the driver on the basis of a state of the driver's eyelids or the degree of eye opening on the image from the driver monitor camera 70. In a case where the driver's eyelids hang down more than the eyelids when awake, the degree of eye opening is lower than the degree of opening when awake, a frequency of blinking is higher than the frequency when awake, or the time spent closing the eyes between blinks is longer than the time when awake, the degree of awakeness of the driver is low. The driver state determiner 152 determines that the driver is not awake in a case where the calculated degree of awakeness is less than a threshold value and determines that the driver is awake in a case where the calculated degree of awakeness is equal to or more than the threshold value.

The driver state determiner 152 estimates an orientation of the driver's line of sight or face from the image from the driver monitor camera 70 and determines whether or not the driver is facing the front (that is, whether or not the task of front monitoring is being performed) on the basis of the estimated orientation of the line of sight or the face.

The driver state determiner 152 determines whether or not a first predetermined time has elapsed from a certain starting point in a case where the driver is not awake and/or is not facing the front (step S104). The starting point is, for example, a time point at which the own vehicle M reaches a section where the event involving a lane change is planned on the route to the destination and is typically a time point at which a lane change is required for passing or the like.

In a case where the first predetermined time has not elapsed from the starting point, the driver state determiner 152 returns the process to S102, and subsequently determines whether the driver is awake and facing the front.

The driver state determiner 152 may determine whether or not the own vehicle M has traveled a first predetermined distance from the starting point, instead of determining whether or not the first predetermined time has elapsed from the starting point.

In a case where the driver is awake and facing the front within a period from the starting point until the first predetermined time elapses, or from the starting point until the own vehicle M travels the first predetermined distance, the device controller 156 uses the HMI 30 to request an approval operation for a lane change (step S106). The approval operation is an operation indicating an intention that the driver approves that the automated driving control device 100 automatedly changes a lane of the own vehicle M and is typically to operate the direction indicator lever 92. The approval operation may be performed by operating the touch panel, the switch, or the like of the HMI 30 instead of or in addition to operating the direction indicator lever 92.

For example, the device controller 156 requests the driver to perform an approval operation by displaying a sentence or an image for prompting the driver to operate the direction indicator lever 92 on the display device of the HMI 30.

When the driver performs the approval operation, the device controller 156 activates the direction indicator 90 (step S108).

Next, the action plan generator 140 generates a target trajectory on the basis of the event involving a lane change, and the second controller 160 controls steering and a speed of the own vehicle M on the basis of the target trajectory, so that the own vehicle M changes lanes (step S110).

On the other hand, in the process in S104, in a case where the first predetermined time has elapsed from the starting point, or in a case where the own vehicle M has traveled the first predetermined distance from the starting point, the device controller 156 activates the direction indicator 90 without an approval operation (step S112). That is, in a case where the driver does not awaken and/or is not facing the front within the period from the starting point until the first predetermined time elapses, or from the starting point until the own vehicle M travels the first predetermined distance, the device controller 156 activates the direction indicator 90 without an approval operation.

Next, the driver state determiner 152 determines whether or not the driver is facing the front (step S114).

In a case where it is determined that the driver is not facing the front, the driver state determiner 152 determines whether or not a second predetermined time has elapsed from a time point at which the first predetermined time has elapsed or a time point at which the own vehicle M has traveled the first predetermined distance (hereinafter, referred to as a primary time point) (step S116). The second predetermined time may be the same as or different from the first predetermined time.

The driver state determiner 152 may determine whether or not the own vehicle M has traveled a second predetermined distance from the primary time point, instead of determining whether or not the second predetermined time has elapsed from the primary time point. The second predetermined distance may be the same as or different from the first predetermined distance.

In a case where the driver is facing the front within a period from the primary time point until the second predetermined time elapses, or from the primary time point until the own vehicle M travels the second predetermined distance, the process proceeds to S110. That is, the action plan generator 140 generates a target trajectory on the basis of the event involving a lane change, and the second controller 160 controls steering and a speed of the own vehicle M on the basis of the target trajectory, so that the own vehicle M changes lanes.

On the other hand, in a case where the driver still is not facing the front within the period from the primary time point until the second predetermined time elapses, or from the primary time point until the own vehicle M travels the second predetermined distance, the device controller 156 uses the HMI 30 to output information for prompting the driver to face the front (step S118).

Next, the driver state determiner 152 determines whether or not the driver is facing the front (step S120).

In a case where the driver began to face the front after prompting the driver to face the front, the process proceeds to S110. That is, the action plan generator 140 generates a target trajectory on the basis of the event involving a lane change, and the second controller 160 controls steering and a speed of the own vehicle M on the basis of the target trajectory, so that the own vehicle M changes lanes.

On the other hand, in a case where the driver is not facing the front after prompting the driver to face the front, the second controller 160 cancels the lane change (step S122). Consequently, the processes in this flowchart are finished.

Process Flow Based on Degree of Awakeness

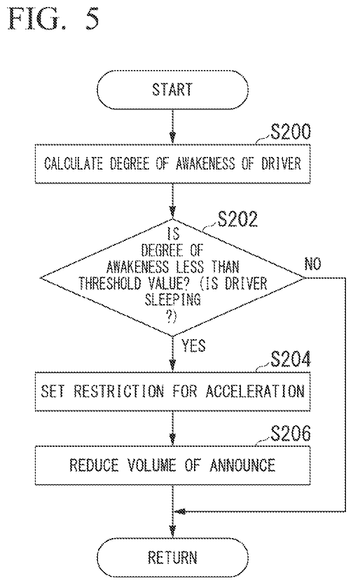

Hereinafter, a flow of a series of processes based on the degree of awakeness of a driver will be described by using a flowchart. FIG. 5 is a flowchart showing an example of a flow of a series of processes based on the degree of awakeness of the driver. The processes in this flowchart may be repeatedly executed in a predetermined cycle.

First, the driver state determiner 152 calculates the degree of awakeness of the driver on the basis of a state of the driver's eyelids and the degree of eye opening on the image from the driver monitor camera 70 (step S200).

Next, the action plan generator 140 determines whether or not the degree of awakeness of the driver is less than a threshold value (step S202).

The action plan generator 140 sets a restriction for acceleration of the own vehicle M (horizontal acceleration or vertical acceleration) such that the driver does not wake up in a case where the degree of awakeness of the driver is less than the threshold value, that is, in a case where the driver is considered to be sleeping (step S204). Consequently, a lane change or acceleration/deceleration is restricted.

Next, the device controller 156 reduces a volume of the HMI 30 or a volume of the direction indicator 90 such that the driver does not wake up (step S206). Consequently, the processes in this flowchart are finished.

According to the embodiment described above, the automated driving control device 100 detects some or all of the degree of awakeness, an orientation of the face, and an orientation of the line of sight of a driver of the own vehicle M and changes a lane change mode on the basis of a detection result thereof. Consequently, it is possible to perform a more comfortable lane change for a driver.

Hardware Configuration

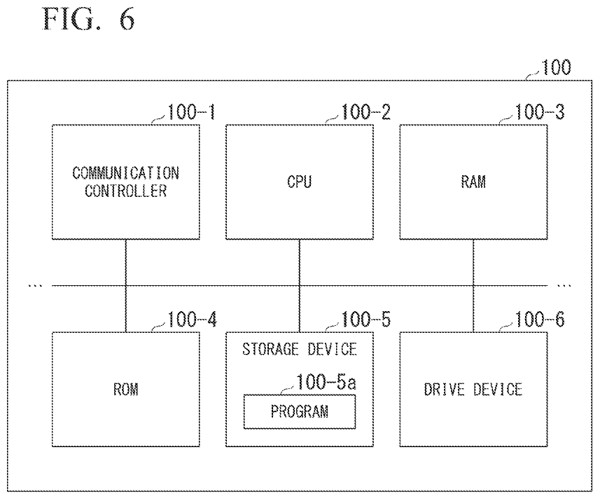

FIG. 6 is a diagram showing an example of a hardware configuration of the automated driving control device 100 of the embodiment. As shown in FIG. 6, the automated driving control device 100 is configured to include a communication controller 100-1, a CPU 100-2, a RAM 100-3 used as a working memory, a ROM 100-4 storing a boot program or the like, a storage device 100-5 such as a flash memory or an HDD, and a drive device 100-6 that are connected to each other via an internal bus or a dedicated communication line. The communication controller 100-1 performs communication with constituents other than the automated driving control device 100. The storage device 100-5 stores a program 100-5a executed by the CPU 100-2. The program is loaded to the RAM 100-3 by a direct memory access (DMA) controller (not shown) or the like and is executed by the CPU 100-2. Consequently, at least one of the first controller 120 and the second controller 160 is realized.

The embodiment described above may be expressed as follows.

A vehicle control device including:

a storage medium storing computer-readable instructions; and

a processor connected to the storage medium,

in which the processor executes the computer-readable instructions to be configured to

detect some or all of the degree of awakeness of a driver of a vehicle, an orientation of the face of the driver, and an orientation of the line of sight of the driver,

change a lane of the vehicle by controlling at least one of a speed and steering of the vehicle, and

change a mode of changing a lane on the basis of the detected result.

As mentioned above, the mode for carrying out the present invention has been described by using the embodiment, but the present invention is not limited to the embodiment, and various modifications and replacements may occur within the scope without departing from the spirit of the present invention.

What is claimed is:

1. A vehicle control device comprising:
a detector that detects some or all of a degree of awakeness of a driver of a vehicle, an orientation of a face of the driver, and an orientation of a line of sight of the driver; and
a driving controller that subjects the vehicle to a lane change by controlling at least one of a speed and steering of the vehicle,
wherein the driving controller changes a mode of the lane change on the basis of a detection result from the detector.

2. The vehicle control device according to claim 1,
wherein the driving controller
determines whether or not the driver is facing the front in the vehicle within a period from a time point at which the lane change is possible until a predetermined time elapses, or from the time point at which the lane change is possible until the vehicle travels a predetermined distance on the basis of the detection result from the detector, and
performs the lane change in a case where it is determined that the driver is facing the front in the vehicle within the period.

3. The vehicle control device according to claim 2,
wherein, in a case where it is determined that the driver is not facing the front in the vehicle within the period, the driving controller outputs information for prompting the driver to face the front in the vehicle by using an outputter.

4. The vehicle control device according to claim 1,
wherein the driving controller
determines whether or not the driver is facing the front in the vehicle within a first period from a time point at which the lane change is possible until a first predetermined time elapses, or from the time point at which the lane change is possible until the vehicle travels a first predetermined distance on the basis of the detection result from the detector,
performs the lane change in a case where it is determined that the driver is facing the front in the vehicle within the first period,
in a case where it is determined that the driver is not facing the front in the vehicle within the first period, activates a direction indicator and determines whether or not the driver is facing the front in the vehicle within a second period from the first period until a second predetermined time elapses, or from the first period until the vehicle travels a second predetermined distance on the basis of the detection result from the detector, and
in a case where it is determined that the driver is not facing the front in the vehicle within the second period, the driving controller outputs information for prompting the driver to face the front in the vehicle by using an outputter.

5. The vehicle control device according to claim 1,
wherein the driving controller restricts the lane change in a case where the degree of awakeness detected by the detector is less than a threshold value.

6. A vehicle control method of causing a computer mounted on a vehicle to:
detect some or all of a degree of awakeness of a driver of the vehicle, an orientation of a face of the driver, and an orientation of a line of sight of the driver;
subject the vehicle to a lane change by controlling at least one of a speed and steering of the vehicle; and
change a mode of the lane change on the basis of a detected result.

7. A non-transitory storage medium storing computer-readable instructions for causing a computer mounted on a vehicle to execute:
detecting some or all of a degree of awakeness of a driver of the vehicle, an orientation of a face of the driver, and an orientation of a line of sight of the driver;
subjecting the vehicle to a lane change by controlling at least one of a speed and steering of the vehicle; and
changing a mode of the lane change on the basis of a detected result.
